(19) United States
(12) Patent Application Publication
(10) Pub. No.: US 2006/0089915 A1
(43) Pub. Date: Apr. 27, 2006

(54) Computer system for automating the controlled distribution of documents

(76) Inventors: Suresh Kumar Kantholy, Hougang Central (SG); Cheong Hiong Anthony Chong, Singapore (GB); Chin Yong Marcus Teo, Singapore (SG); Huijuan Yang, Singapore (SG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/515,989

(22) PCT Filed: May 28, 2003
(86) PCT No.: PCT/SG03/00124

§ 371 Date: Sep. 30, 2005

(30) Foreign Application Priority Data
May 28, 2002 (SG) 200203160-7

(51) Int. Cl. G06Q 99/00

(52) U.S. Cl. 705/57

(57) ABSTRACT

The present invention is the system for providing secure access to certified and authenticated electronic documents. The system enables authenticating or certifying authorities (103) to make available electronic documents in a secure repository (101). The system provides for online viewing of documents without their certification marks and direct printing of documents to a printer remote from the repository (101) in a secure manner.

### FIELD OF THE INVENTION

This invention relates to a computer system for automating the distribution of documents requiring control of the parties who can view and print the documents.

### SUMMARY OF THE PRIOR ART

In the prior art when a party wished to limit who could print a document the party would restrict printing of the document by printing the document themselves and physically delivering a printed copy to the party requesting the document As an example while an exporter can currently in some jurisdictions file an application for a certificate of origin electronically there is still the requirement to physically collect or have delivered the certificate once the certificate has been processed and printed.

US 2001/0013025 describes a method of controlling the printing process by having specialised software print directly to a printer. This method requires that the computer that is to be used for printing have the specialised software installed.

Other software such as Adobe Acrobat allows the creation of files that can be protected by limit printing but because the user has a copy of the file the there is a security risk that the protection can be overridden.

### SUMMARY OF THE INVENTION

The present invention may broadly be said to consist in a computer system for allowing the secure creation of documents requiring certification or authentication from a certifying or authenticating authority in electronic form upon application therefor by subscribers and for controllably releasing such documents in copy-protected paper form to third parties comprising:

means for assembling the text of said documents;

a repository for storing assembled documents and certification or authentication indicia appropriate to selected classes of documents;

a subscriber interface for requesting the assembly of a specific document and for supplying data specific to each request for assembly into that document,

means for notifying the appropriate certifying or authenticating authority of a request for a document requiring certification or authentication by that authority;

an approval interface for enabling said certifying authority to cause its associated stored indicia to be applied to be inserted in the document for which a request has been received;

means for allowing a third party to view the assembled document without the indicia inserted; and

means which allows said third party to request a print of one copy only of said document including indicia on a printer local to third party.

To those skilled in the art to which the invention relates, many changes in construction and widely differing embodiments and applications of the invention will suggested themselves without departing from scope of the invention as defined in the appended claim. The disclosures and the descriptions herein are purely illustrative and are intended to be in any sense

### BRIEF DESCRIPTION OF THE DRAWINGS

FIG. 1 is a block diagram showing the interaction of the parties of the present invention.

FIG. 2 is a block diagram showing the document creation process of the preferred embodiment of the present invention.

### DETAILED DESCRIPTION OF THE PRESENT INVENTION

A method and apparatus for providing secure distribution of electronic documents is described. The generic trusted document repository will be described with reference to a Certificate of Origin but it is to be understood that the generic trusted document repository is not limited to such documents and any reference to such documents in the description is for illustrative purposes only. The generic trusted document repository is also suitable for distribution of other certified or secure documents where it is desirable to restrict the number of printed copies made by a recipient.

A Certificate of Origin (CO) is a document, required by foreign governments, declaring that goods in a particular international shipment are of a certain country of origin.

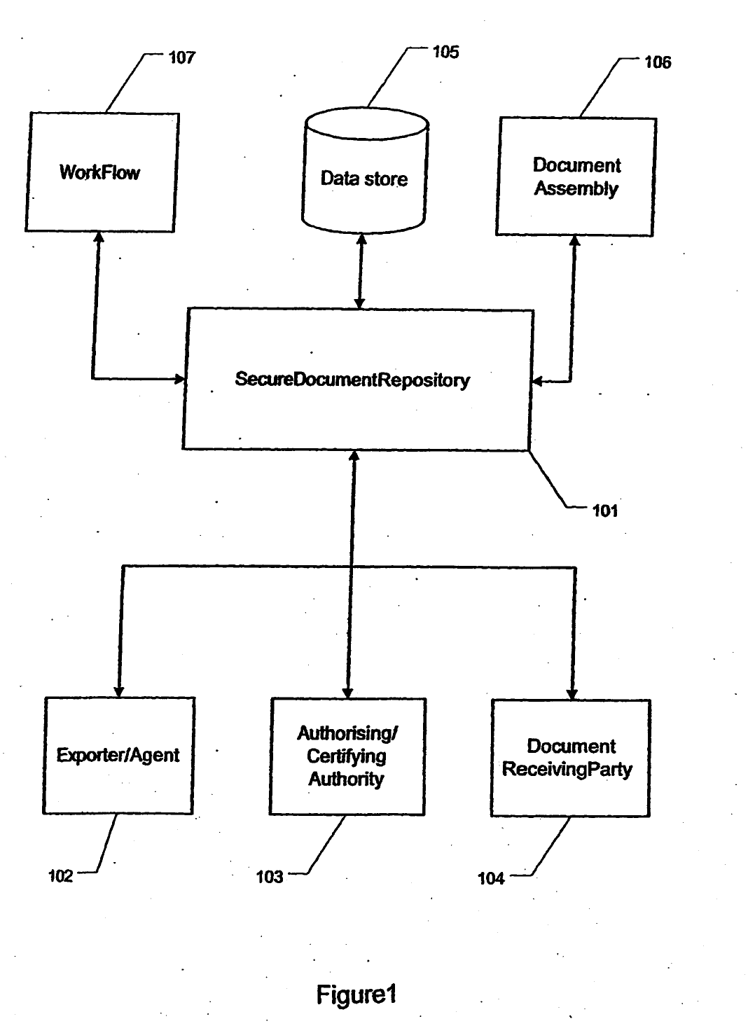

Referring to FIG. 1 the secure document repository 101 has an interface for communicating with an exporter or agent 102, an interface for communicating with an authorising authority 103, an interface for communicating with a document receiving party 104 and a data store 105. Communication between the document repository and the exporter/agent 102, the authoring authority 103, and the document receiving party 104, is made using secure communication methods such as public key encryption infrastructure to ensure that all communications are secure and trusted. In addition to interfaces to communicate with the parties, the secure document repository has a document assembly engine 106 for assembling the documents and a work flow engine 107 for ensuring the progress of the document and communication with the various parties follows a work flow agreed to by the authorising authority. The repository has a data store to store information on the various parties.

In the preferred embodiment the communication interface is provided by a web server. The web server provides the communication channel between the parties and the repository. The web server has an interface to enable applicants/agents to register with the repository. In alternative forms the repository would communicate with some of the parties using other known secure electronic data interchange methods such as MIME based secure EDI.

Because of the different requirements of certifying authorities and in particular the differences in information collected and the document assembly process, before it can commence using the repository a new certifying authority will have to have its business process rules and other information loaded into the repository by the system administrator. Likewise if an existing authority adds a new certification process or changes an existing certification process then the system administrator will need to change the business process rules. Certifying authorities who certify using the repository will provide the repository with electronic images of the necessary official stamps, signatures and/or other certifying indicia.

A certifying authority will, via a web interface and online form be able to change information the system stores such as address, telephone numbers and authorisation codes.

In the preferred embodiment all communication will employ Public Key Infrastructure (PKI) to assure that all transactions are secured and trusted. The use of PKI ensures that all transactions that take place between the parties over the Internet are confidential, such that the information transferred is kept private. PKI also ensures data entry integrity by making sure that the information communicated between the various parties is not being tampered with by third parties. PKI also ensures the authority of the sender through the use of signed digital certificates and it also follows that the sender cannot deny sending a document that has been received.

In the case of new exporters/agents or other parties the repository will collect information and images of signatures, seals and other indicia via an online form and store the information in the data store. The repository will, via the web server, issue a user identification code and security code that the user will have to enter each time, a new communication session is commenced with the web server. This is in addition to the use of public key infrastructure. The repository will store the user identification code and security code in association with the data collected from the application form.

To request electronic certification of documents from a particular certifying authority a user will apply to the authority via an online form served by the repository web server. The repository will the users request and forward the user's request and details of the user to the identified certifying authority for approval. In the preferred embodiment the repository would via electronic mail notify the certifying authority that a user had requested to be allowed to apply for certification online, the authority would then log onto the repository via the web saver and authorise the use or reject the application as the case may be.

In an alternative embodiment the repository would communicate with the certifying authority using electronic data interchange methods and the repository would receive the approval back in the same manner. Once approval has been granted the repository will record that the user is allowed to apply for certified documents from the certifying authority that has approved the user so to do in it's data store in association with the user identification code. The user will need to apply using the respiratory web server for approval for every authority the user seeks certified documents from.

Via online forms the repository web server will allow users to delegate authority to agents to enable agents to apply for certified documents on their behalf. The agent to whom the delegation is made must also be an authorised user and authorised by the relevant coming authority. The repository web server will store the delegations information in association with information kept on the exporters/agents and certifying authority in the repository data store.

A user may limit an agent's delegation to a applying for certification from particular certifying authorities. This is done via an online form served by the, repository web server. The repository will not allow an agent to further delegate the authority to apply for certification unless permitted by the user.

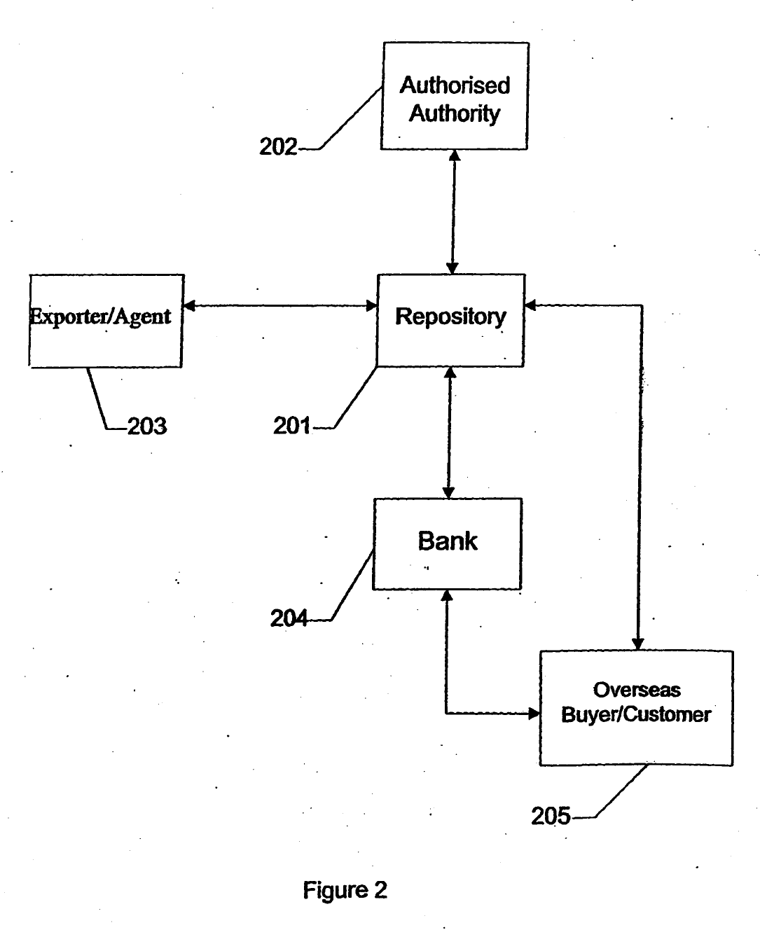

Referring to FIG. 2 to obtain a certificate of origin an applicant 203, being an exporter or an agent, will log on to the repository web server 201 and authenticate themselves. In addition to identification using PKI the repository will check the authentication and if the user is authorised will present a web page presenting the user with a set of option. After selecting apply for certification the user will be presented with a list of certified documents that the user can apply for online. The repository web server interface will create the list by checking in the data store for the list of certifications that the user can apply online for. The applicant will then select a certification to apply for and an online application form will be presented. The fields presented to the user will reflect the business rules stored in the system for the certification the user is applying for. The user will fill in the electronic form and submit the form to the repository web server. The repository will pre-fill in some of the fields based o information stored in its data store.

As part of the application process the applicant may supply information such as an electronic mail address of a third party such as a bank 204 to the repository, to enable the third party who needs the certificate of origin to be notified when the certificate of origin has been issued. The business rules of the certifying authority will be checked to ensure the applicant has provided the required information and if not the user will be prompted to fill in the required fields in the application form. On successful submission the applicant will be notified via the web server that their application has been accepted for processing. The information provided by the user via the web based application form is stored in the data store.

In an alternative embodiment, the information could be generated by the applicant's computer system and transferred using known secure electronic data interchange methods to the generic rusted document repository.

If the repository web server identifies that it is an agent applying then, having authenticated the agent, the repository will present from its data store a list of users the agent is authorised to apply on behalf of, and require a selection from this list before providing the agent with a choice of certifications to apply for.

When an application is made the repository notifies the issuing authority 202 via electronic mail that an application has been made and the issuing authority will approve or reject the application using an online web interface or using secure electronic data interchange methods. Issuing authorities may delegate the approval of certification to the repository. The approval of the repository may be limited to, for example, certifications below a certain threshold value or a particular type of certification. For quality control delegation may require that a proportion of applications is sent to the authority for checking before approval.

When the issuing authority has approved the application the document assembly engine will create a two certificates using the data provided by the applicant, the certifying authority business rules. After the documents are created the repository will store in the documents in it data store. The stored certificates will be in a form approved by the issuing authority. One version of the document is created without an official indicia and one version is created incorporating the official indicia, repository document number and repository security code.

Once the document is assembled the repository electronically notifies the applicant 203 (and if requested the third party 204 requiring the document) via electronic mail that the document is available for electronic collection. The notification will include a web page address based on the repository document number and an appropriate security code so that the party is able to view a copy of the digital document via the Internet. A third party such as a bank my forward the information to an overseas bank or customs office 205 that requires the document

In a further less preferred embodiment the applicant for the certified or authenticated document could apply directly to the certifying authority using whatever means the certifying authority specified. The certifying authority would then approve or reject the application and if rejected communicate the rejection to the applicant. If the application was approved the authority would apply to the repository for a document number and a security code for accessing the document The certifying authority would then create two documents one document without the security code insignias, seals and document number and another document including the security code, seals and document number. Using electronic means either a web interface or secure EDI the would then upload the documents to the repository so that the documents could be made available.

The authority would then notify the applicant and/or if facilities are provided by the authority for notifying third parties of the creation of the document.

If the issuing authority rejects an application then the applicant and if applied for by an agent are notified of the rejections. To view the document the URL provided in the electronic mail notifying that the document has been created is entered into a web browser the document repository will via a web server request that the security code be provided before the document can be viewed online before the document can be viewed online. The copy that is available for viewing online does not include an official indicia. The official indicia is not available for viewing online as this would allow anyone who is able to view the document online to print multiple copies of the document

In order for the party who desires a printed copy of the document to print the document the party logs on to the repository and requests that a copy be printed. The authorising authority can control who can print official copies of the document and can limit the number of copies a party can print.

Parties who desire to be able to print certified copies may need to register with the repository and be authorised by the certifying authority who certified documents they wish to print depending on the requirements of the certifying authority. The application can be made online via the repository web interface and is processed and the information stored in the same manner as if the party who wishes to print was a party who wished to apply online.

In order to print the documents in a secure and controlled manner, the repository forwards a data stream in a print control language directly to a printer. The data stream corresponds with the fully certified document including certifications (seals, stamps, signatures etc). Examples of such printer control languages included pcl and postcript.

In the preferred embodiment Sun Microsystems Java Print Service API via a java applet is used to print a data stream in a printer control language directly to a printer without permitting user intervention. Because the Java Virual Machine is usually installed on a computer with a web browser it is only necessary to download the Java Runtime Environment. Such a download need only be done once and is available at no charge. In addition the security model built into Java means that the receiving party can be sure that the applet was created by a trusted party, in this case the repository.

Any other process that allowed the printing of documents directly to a printer from an web browser without user intervention would also be suitable. This process prevents the user from saving a copy of the print file and therefore being able to print multiple copies of the certified document

In addition to controlling the printing of sewed documents in this manner the document will preferably have an embedded security watermark image, a document number and document identification code printed on it. When a document is copied the copy will reveal that the document is not the original as printed from the repository because of the watermark. Printing the repository document number and document identification number on the certificate will enable a party who has been presented with a paper copy to check that the paper copy corresponds to the copy held in the repository.

1. A computer system for controllably releasing certified or authenticated documents in copy-protected paper form to third parties comprising:
an approval interface for enabling a certifying authority to approve a certified or authenticated document for release;
third party display means for allowing a third party to view a said document approved for release without certification or authentication indicia inserted; and
third party print means which allows said third party to request a print of a limited number of copies only of said document including certification or authentication indicia on a printer local to that third party.

2. A computer system as claimed in claim 1 including:
a repository for storing documents and associated indicia;
said approval interface includes means for a certifying or authenticating authority to cause documents with and without inserted indicia to be stored in said repository;
said third party display means is programmed to retrieve a said document without indicia for viewing by a third party; and
said third party print means is programmed to retrieve a said document with indicia for printing on said printer local to said third party.

3. A computer system as claimed in claim 1 for allowing the secure creation of documents requiring certification or authentication from a certifying or authenticating authority in electronic form including:
means for assembling the text of a said document; and
a repository for storing assembled documents and certification or authentication indicia appropriate to selected classes of documents.

4. A computer system as claimed in claim 1 for allowing the secure creation of documents requiring certification or authentication from a certifying or authenticating authority in electronic form upon application therefor by subscribers and for controllably releasing such documents in copy-protected paper form to third parties comprising:
a subscriber interface for requesting the assembly of a specific document and for supplying data specific to each request for assembly into that document;
means for assembling the text of a said document;
a repository for storing assembled documents and certification or authentication indicia appropriate to selected classes of documents; and
means for notifying the appropriate certifying or authenticating authority of a request for a document requiring certification or authentication by that authority.

5. A method for controllably releasing certified or authenticated documents in copy-protected paper form comprising the steps of:
allowing a party to view a said document approved for release without certification or authentication indicia inserted; and
allowing said party to print a limited number of copies only of said document including certification or authentication indicia on a printer local to that third party.

6. A method for controllably releasing certified or authenticated documents in copy-protected paper form as claimed in claim 5 further comprising storing said documents with and without inserted indicia wherein:
said step of allowing a party to view a said document comprises allowing said party to view a said stored document without certification or authentication indicia inserted; and
said step of allowing said party to print comprises allowing said party to print said stored document with certification or authentication indicia inserted.

7. A method for controllably releasing certified or authenticated documents in copy-protected paper form as claimed in claims 5 or 6 claim 5 wherein the step of allowing a party to view a said document comprises:
receiving a request to view said document from a party;
ensuring said party is approved to view said document; and
making said document without indicia available for viewing by said party upon request of said party.

8. A method for controllably releasing certified or authenticated documents in copy-protected paper form as claimed in claim 5 wherein the step of allowing said party to print said document including certification or authentication indicia on a printer local to that third party comprises:
receiving a request to print said document from a party;
ensuring said party is approved to print said document; and
printing said document with indicia on a printer local to said party

9. A method for controllably releasing certified or authenticated documents in copy-protected paper form as claimed in claim 5 including the steps of:
assembling the text of a said document; and
storing assembled documents and certification or authentication indicia appropriate to selected classes of documents.

10. A method for controllably releasing certified or authenticated documents in copy-protected paper form as claimed in claim 5 including the steps of:
receiving subscriber data and request for the assembly of a specific document;
assembling said document without certification or authentication indicia for said viewing; and
assembling said document with certification or authentication indicia for said printing.

11. A method for controllably releasing certified or authenticated documents in copy-protected paper form as claimed in claim 10 including the steps of:
verifying that said document can be certified or authenticated; and
certifying or authenticating said document.

12. A method for controllably releasing certified or authenticated documents in copy-protected paper form as claimed in claim 10 including the steps of:
notifying an appropriate certifying or authenticating authority of a request for a document requiring certification or authentication by that authority;
receiving from said authority approval to certify said document; and
certifying or authenticating a said document.

13. A method for controllably releasing certified or authenticated documents in copy-protected paper form as claimed in claim 10 including the step of notifying said subscriber that an authenticated document is available.

14. A method for controllably releasing certified or authenticated documents in copy-protected paper form as claimed in claim 10 including the step of notifying at least one third party that an authenticated document is available.

15. A method for controllably releasing certified or authenticated documents in copy-protected paper form comprising the steps of:
receiving subscriber data and request for the assembly of a specific document from a subscriber;
verifying that said document can be certified or authenticated;
certifying or authenticating said document; and
notifying a third party indicated by said subscriber data that an authenticated document is available.

16. A method for controllably releasing certified or authenticated documents in copy-protected paper form as claimed in claim 15 including the step of notifying said subscriber that the authenticated document is available.

17. A method for controllably releasing certified or authenticated documents in copy-protected paper form as claimed in claim 15 wherein said step of verifying that said document can be certified or authenticated comprises:
notifying an appropriate certifying or authenticating authority of a request for a document requiring certification or authentication by that authority; and
receiving from said authority approval to certify said document.
